(19) United States
(12) Patent Application Publication
(10) Pub. No.: US 2015/0339558 A1
(43) Pub. Date: Nov. 26, 2015

(54) PRINTING APPARATUS AND PRINTING METHOD

(71) Applicant: Seiko Epson Corporation, Tokyo (JP)

(72) Inventor: Masashi KANAI, Azumino (JP)

(21) Appl. No.: 14/718,646

(22) Filed: May 21, 2015

(30) Foreign Application Priority Data
May 22, 2014 (JP) 2014-106219

(51) Int. Cl. G06K 15/00; G06K 15/02

(52) U.S. Cl. CPC G06K 15/4065; G06K 15/021

(57) ABSTRACT

A printing apparatus includes a light receiving sensor provided in one of a moving unit and a non-moving unit; a light source provided in the other of the moving unit and the non-moving unit; a measurement unit that measures an intensity of light that is emitted from the light source and reflected on a printing medium to be printed on, a plurality of times, while the moving unit moves; and a determination unit that determines a type of the printing medium to be printed, based on an intensity of the light that is measured a plurality of times by the measurement unit.

### BACKGROUND

1. Technical Field

The present invention relates to a printing apparatus, and a printing method.

2. Related Art

JP-A-8-314327 describes a technology in which light emitted by an LED, which is a light emitting element, is reflected on a recording material, specular reflected light and diffuse reflected light are respectively received by a photodiode which is a light receiving element, and the paper type of the recording material is determined and recognized based on an intensity ratio of the specular reflected light and the diffuse reflected light.

However, in JP-A-8-314327, since the paper type is determined by using the intensity ratio of the specular reflected light and the diffuse reflected light, it is difficult to determine the paper type having the similar intensity ratio.

### SUMMARY

An advantage of some aspects of the invention is to determine more accurately the paper type.

According to a first aspect of the invention, a printing apparatus includes a light receiving sensor provided in one of a moving unit and a non-moving unit; a light source provided in the other of the moving unit and the non-moving unit; a measurement unit that measures the intensity of light that is emitted from the light source and reflected on a printing medium to be printed on, a plurality of times, while the moving unit moves; and a determination unit that determines a type of the printing medium to be printed on, based on the intensity of the light that is measured a plurality of times by the measurement unit. Therefore, since it is possible to measure the intensity of the reflected light at each of a plurality of positions of the printing medium by using the movement of the moving unit, it is possible to more accurately determine the type of medium in view of the intensity of reflected light at a plurality of different positions of the printing medium.

In the printing apparatus, the moving unit may be a print head, and the measurement unit may measure the intensity of light reflected on the printing medium to be printed on while the print head moves. Therefore, it is possible to measure the light intensity at a plurality of head positions with a simple configuration using scanning of the print head.

The printing apparatus may further include a property information storage unit that stores a first type of property information that is generated based on the intensity of light that is measured in advance, for each type of the printing medium, and the determination unit may determine the type of the printing medium to be printed on, based on a second type of property information of the printing medium to be printed on that is generated based on the intensity of light that is measured the plurality of times and the first type of property information that is stored in the property information storage unit. Therefore, since the intensity of the reflected light at each of a plurality of positions for the various printing mediums that are measured in advance and the intensity of the reflected light at each of the plurality of positions for the printing medium to be printed on are considered, it is possible to increase not only the color of the printing medium but also the discrimination accuracy of the properties such as gloss, and accurately determine the type of medium even when the properties are slightly different.

The printing apparatus may further include a printing parameter storage unit that stores a printing parameter used in a printing process, for each printing medium; and a printing unit that performs a printing process on the printing medium to be printed on, according to the printing parameter corresponding to the type of the printing medium that is determined by the determination unit. Therefore, it is possible to perform printing with the printing parameter suitable for the type of the determined printing medium. Further, even if the user sets the type of the printing medium, or even if the setting of types of the printing medium of the user is wrong, it is possible to perform printing with the appropriate printing parameter.

In the printing apparatus, the printing parameter may include a parameter regarding at least one of a color conversion process, a halftone process, an ink discharge amount, a paper feeding process, and a drying process. Therefore, it is possible to reduce the burden on the user which sets a number of printing parameters, depending on the type of printing medium.

In the printing apparatus, one of the light receiving sensor and the light source may include a Fabry-Perot spectrometer. Therefore, it is possible to reduce the size of the light receiving sensor or the light source.

In the printing apparatus, the light source may emit light of at least two or more wavelengths, the light receiving sensor may receive the light of at least two or more wavelengths, the measurement unit may measure an intensity of the light of at least two or more wavelengths that is emitted from the light source and reflected on the printing medium to be printed on, for each of a plurality of times of measurement, and the determination unit may determine the type of the printing medium to be printed on, based on an intensity of the light of at least two or more wavelengths that is measured for each of the plurality of times of measurement. Therefore, since it is possible to measure the intensity of the reflected light of a plurality of wavelengths at each of the plurality of positions of the printing medium by using the movement of the moving unit, it is possible to more accurately determine the type, in view of the intensity of reflected light of a plurality of wavelengths at each of a plurality of different positions of the printing medium.

According to a second aspect of the invention, a printing method of a printing apparatus includes measuring an intensity of light that is emitted from a light source and reflected on a printing medium to be printed on, a plurality of times, while the moving unit moves; and determining a type of the printing medium to be printed on, based on an intensity of the light that is measured a plurality of times by the measurement unit. Therefore, since it is possible to measure the intensity of the reflected light at each of the plurality of positions of the printing medium by using the movement of the moving unit, it is possible to more accurately determine the type, in view of the intensity of reflected light at a plurality of different positions of the printing medium.

### BRIEF DESCRIPTION OF THE DRAWINGS

The invention will be described with reference to the accompanying drawings, wherein like numbers reference like elements.

FIG. 1 is a diagram illustrating a configuration example of a printing apparatus according to an embodiment of the invention.

FIGS. 2A to 2C are diagrams illustrating an arrangement example of a light receiving sensor and a light source unit.

FIG. 3 is a diagram illustrating a configuration example of the light receiving sensor.

FIG. 4 is a diagram illustrating a configuration example of a spectroscopic unit.

FIG. 5 is a flowchart illustrating a processing outline of the printing apparatus.

FIG. 6 is a flowchart illustrating an example of a process for generating and storing paper type data.

FIG. 7 is a flowchart illustrating an example of a printing process.

FIGS. 8A and 8B are diagrams illustrating measured spectral reflectance.

FIGS. 9A to 9D are diagrams illustrating a method for determining a covariance matrix.

FIG. 10 is a diagram illustrating a covariance matrix.

FIGS. 11A to 11E are diagrams illustrating a Mahalanobis distance.

FIG. 12 is a diagram illustrating a state in which the covariance matrix is developed.

FIG. 13 is a diagram illustrating a state in which a principal component value is extracted.

FIGS. 14A to 14C are diagrams illustrating another example of arrangement of the light receiving sensor and the light source unit.

### DESCRIPTION OF EXEMPLARY EMBODIMENTS

### Embodiment

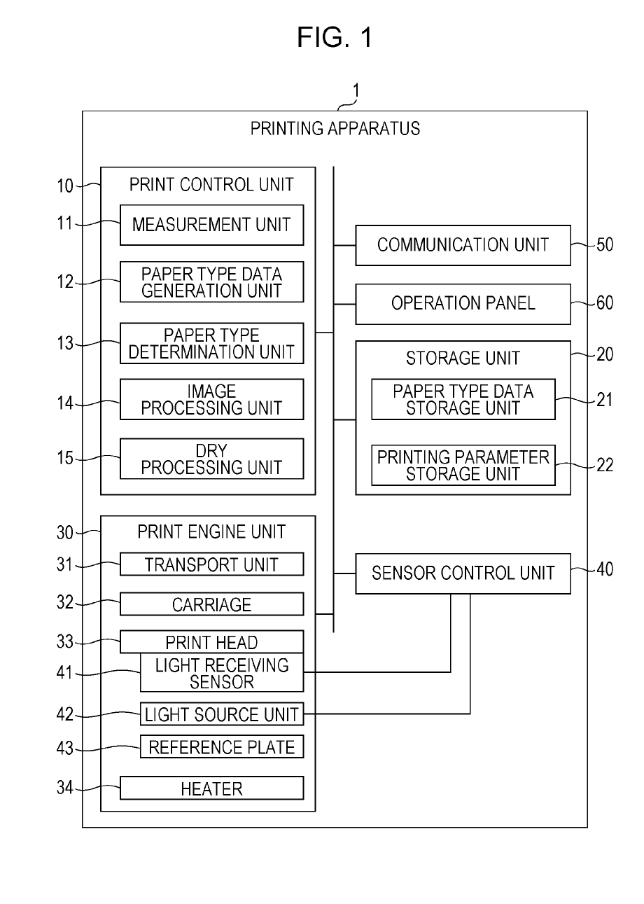

FIG. 1 is a diagram illustrating a configuration example of a printing apparatus according to an embodiment of the invention.

A printing apparatus 1 is, for example, an ink jet type printer. The printing apparatus 1 includes a small light receiving sensor such as a Fabry-Perot spectrometer, and a light source in the inside thereof. Then, in the printing apparatus 1, the light (specular reflected light and diffuse reflected light) that is emitted from a light source and reflected on a printing medium is dispersed by a light receiving sensor, and an intensity (also referred to as the amount of light and brightness) of the dispersed light of each wavelength is measured. Further, printing apparatus 1 determines the paper type of the printing medium, based on the measured intensity of the light of each wavelength. Hereinafter, a detailed description will be made.

The printing apparatus 1 includes a print control unit 10, a storage unit 20, a print engine unit 30, a sensor control unit 40, a light receiving sensor 41, a light source unit 42, a reference plate 43, a communication unit 50, and an operation panel 60.

The communication unit 50 is, for example, a communication interface for communicating in a wired manner or a wireless manner, and is connected to an external apparatus such as a smartphone, a tablet computer, and a personal computer (PC) so as to perform communication. The communication unit 50 transmits information which is input from the print control unit 10, or outputs the information which is received from the external apparatus, to the print control unit 10.

The operation panel 60 includes an operation key for giving various instructions to the printing apparatus 1. If the user operates the operation key, the operation panel 60 outputs an operation signal in response to the details of the operation of the user, to the print control unit 10. Examples of the operation key include “a power key” for turning on or off the power source, “a menu key” for displaying a menu screen for performing various settings, “a cursor key” used for selection of an item in the menu screen, “a determination key” for confirming the selected item, and “a cancel key” used for cancelling an operation, and the like. In addition, the operation key can be implemented by, for example, a hard switch, a touch panel, and the like.

Further, the operation panel 60 includes a display that displays various types of information to the user. The display is, for example, a display such as a liquid crystal display, an electro-luminescence (EL) display, and the like. The operation panel 60 displays an operation screen, a message, a dialog, and the like on the display, in response to the instruction of the print control unit 10.

The print engine unit 30 includes, for example, a paper feed and discharge unit (not illustrated) that feeds and discharges the printing medium, a transport unit 31 that transports the printing medium in a sub-scanning direction, one or more ink cartridges (not illustrated), a print head that ejects ink supplied from the ink cartridges, a carriage 32 having the print head 33 mounted therein, a carriage drive mechanism (not illustrated) that reciprocates the carriage 32 in a main scanning direction, and a heater 34 that heats and dries the ink ejected onto the printing medium. The print head 33 includes a plurality of nozzles that eject ink droplets, and ejects the ink droplets from each nozzle. The print engine unit 30 forms dots on the printing medium by performing a reciprocating movement in the main scanning direction of the carriage 32 (that is, the movement of the print head 33), the transport of the printing medium in the sub-scanning direction, the ejection of the ink droplets from the nozzle of the print head 33, the driving of the heater 34, and the like under the control of the print control unit 10.

Here, a description will be made regarding the arrangement of the light receiving sensor and the light source unit in the present embodiment.

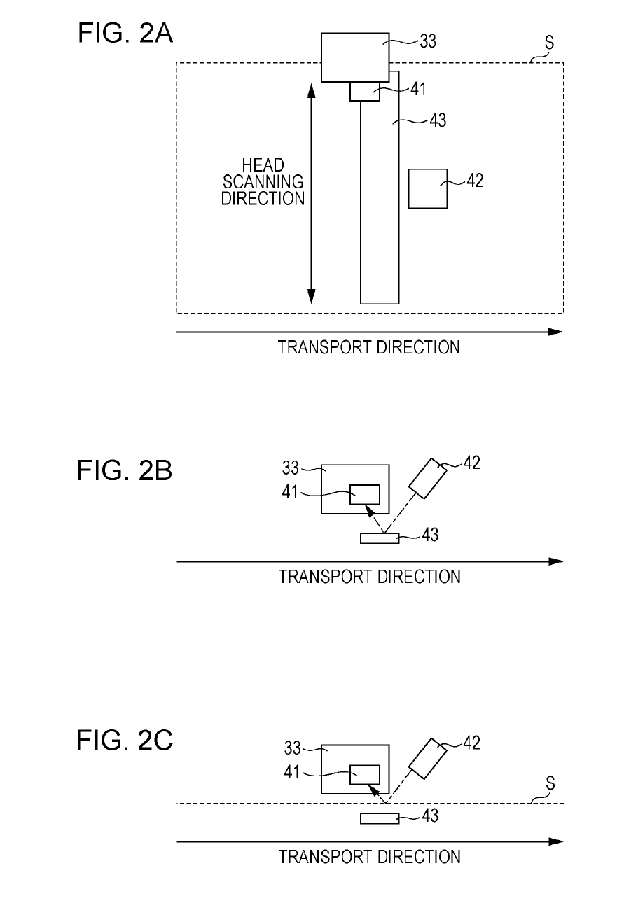

FIGS. 2A to 2C are diagrams illustrating an arrangement example of the light receiving sensor and the light source unit. In FIGS. 2A to 2C, the illustration is focused on the arrangement of the light receiving sensor 41 and the light source unit 42, and other configuration components such as the carriage 32 are appropriately omitted. FIG. 2A is a diagram when the printing apparatus 1 is viewed in a vertical direction relative to the transport direction and the head scanning direction, FIG. 2B is a diagram when the printing apparatus 1 is viewed in the head scanning direction (in a state where the printing medium S is not being transported), and FIG. 2C is a diagram when the printing apparatus 1 is viewed in the head scanning direction (in a state where the printing medium S is being transported). In addition, the transport direction corresponds to the main scanning direction, and the head scanning direction corresponds to the sub-scanning direction.

The light receiving sensor 41 is provided in the print head 33, and an opening unit to be described later faces the direction of the printing medium S and a reference plate 43 such that the light receiving sensor 41 detects the light reflected from the printing medium S and the reference plate 43 to be described later. The light receiving sensor 41 is integrated with the print head 33 by the operation of the carriage 32, and reciprocates in the head scanning direction.

The light source unit 42 is, for example, a light emitting element such as a halogen lamp and a light emitting diode (LED), and a light source capable of emitting the light of two or more wavelengths (for example, light of a certain wavelength range such as a visible area and an ultraviolet area). The light source unit 42 is turned on or off, in response to the instruction of a sensor control unit 40 to be described later.

The light source unit 42 is disposed above the printing medium S, and emits light at least in the direction of the printing medium S and the reference plate 43 to be described later. The light source unit 42 is attached, for example, in a static position such as an inner wall of a housing of the printing apparatus 1.

There is a transport path through which the printing medium S passes in the transport direction below the print head 33, the light receiving sensor 41, and the light source unit 42. The reference plate 43 is disposed below the printing medium S, and extends in the head scanning direction. For example, a white diffusion plate having a small bias of reflection can be used for the reference plate 43. In a state where the printing medium S is not being transported, the reference plate 43 reflects the light emitted from the light source unit 42 to at least the light receiving sensor 41. The printing medium S also reflects the light emitted from the light source unit 42 to at least the light receiving sensor 41.

In this manner, in the present embodiment, with a simple configuration in which the print head 33 is fixed to the light receiving sensor 41 and the light source unit 42 is fixed to a static position such as the inner wall of the housing of the printing apparatus 1, it is possible to receive the light (specular reflected light and diffuse reflected light) reflected from the printing medium S and the reference plate 43, in each head position in the head scanning direction of the print head 33, by the light receiving sensor 41. In other words, it is possible to receive the reflected light at each position by the light receiving sensor 41, while changing the relative position of the light receiving sensor 41 and the light source unit 42.

In addition, the print head 33 having the light receiving sensor 41 provided therein corresponds to a moving unit of the invention. Further, a static position such as the inner wall of the housing of the printing apparatus 1 to which the light source unit 42 is fixed corresponds to the non-moving unit of the invention.

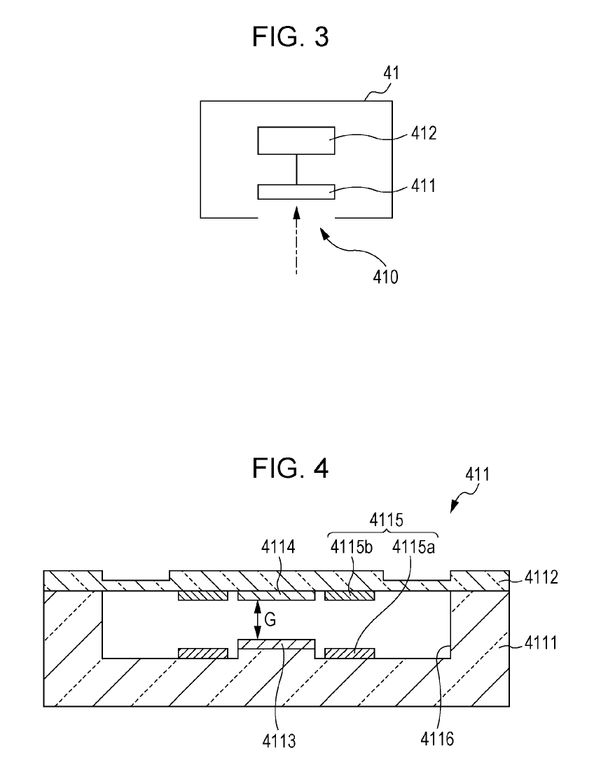

For example, as illustrated in FIG. 3 (diagram illustrating a configuration example of the light receiving sensor), the light receiving sensor 41 includes a light guide unit 410, a spectroscopic unit 411, and a light receiving unit 412. In addition, FIG. 3 illustrates a schematic internal configuration of the light receiving sensor 41.

The light guide unit 410 is a member that guides the reflected light from the printing medium S or the reference plate 43 to the spectroscopic unit 411. The light guide unit 410 includes, for example, an opening unit (also referred to as “aperture”) through which the reflected light from the printing medium S or the reference plate 43 passes to the light receiving sensor 41 and which guides the light to the spectroscopic unit 411. Of course, the light guide unit 410 is not limited to the above configuration, and may include, for example, any one or two or more of configuration components such as an opening unit, an optical fiber, and a lens. In addition, the optical fiber and lens condense the reflected light from the printing medium S or the reference plate 43 and guide the reflected light to the spectroscopic unit 411.

The spectroscopic unit 411 is a member that disperses the light that is guided through the light guide unit 410 into light of certain wavelengths. The spectroscopic unit 411 is rectangular when viewed in a plan view, and a long side is formed to, for example, 10 mm. FIG. 4 (diagram illustrating a configuration example of the spectroscopic unit) is a cross-sectional view when the center of the spectroscopic unit 411 is taken along the long side or the short side direction.

The spectroscopic unit 411 includes a fixed substrate 4111 and a movable substrate 4112. The fixed substrate 4111 and the movable substrate 4112 are respectively made from, for example, various glasses such as soda glass, crystalline glass, and quartz glass, quartz, and the like. Then, the fixed substrate 4111 and the movable substrate 4112 are formed integrally by being bonded, for example, by room temperature activation bonding.

Further, a fixed reflection film 4113 and a movable reflection film 4114 are provided between the fixed substrate 4111 and the movable substrate 4112. The fixed reflection film 4113 is fixed to a surface facing the movable substrate 4112, in the fixed substrate 4111. The movable reflection film 4114 is fixed to a surface facing the fixed substrate 4111, in the movable substrate 4112. Further, the fixed reflection film 4113 and the movable reflection film 4114 are opposed to each other through a gap G.

Further, an electrostatic actuator 4115 for adjusting the spacing of the gap G between the fixed reflection film 4113 and the movable reflection film 4114 is provided between the fixed substrate 4111 and the movable substrate 4112.

The fixed substrate 4111 is formed by processing, for example, a glass substrate having a thickness of 500 μm through etching. An electrode forming groove 4116 that is formed by etching is formed in the fixed substrate 4111. A first electrode 4115a constituting an electrostatic actuator 4115 is formed in the electrode forming groove 4116. The first electrode 4115a is connected to the sensor control unit 40 (see FIG. 1) through an electrode lead portion (not illustrated).

The movable substrate 4112 is formed by processing, for example, a glass substrate having a thickness of 200 μm through etching. A second electrode 4115b that faces the first electrode 4115a through a gap and constitutes the electrostatic actuator 4115 is formed in the movable substrate 4112. The second electrode 4115b is connected to the sensor control unit 40 (see FIG. 1) through the electrode lead portion (not illustrated).

An electrostatic attractive force is activated between the first electrode 4115a and second electrode 4115b by the voltage output from the sensor control unit 40, the spacing of the gap G is adjusted, and the transmission wavelength of the light passing through the spectroscopic unit 411 is determined according to the gap spacing. In other words, the light passing through the spectroscopic unit 411 is determined by appropriately adjusting the gap spacing by the electrostatic actuator 4115, and the light that has passed through the spectroscopic unit 411 is received by the light receiving unit 412.

Returning back to the description of FIG. 3, the light receiving unit 412 is a member that detects light. Examples of the light receiving unit 412 include a photodiode, a photo IC, and the like. If the light that has passed through the spectroscopic unit 411 is received, the light receiving unit 412 generates an electrical signal corresponding to the intensity and the like of the received light. Then, the light receiving unit 412 outputs the generated electrical signal to the sensor control unit 40.

The light receiving unit 412 outputs an electrical signal that is accumulated according to the intensity of light or the like, based on a drive control signal that is output from the sensor control unit 40, to the sensor control unit 40. In other words, the light receiving unit 412 outputs the accumulated electrical signal to the sensor control unit 40, at the timing of the drive control signal.

Returning back to the description of FIG. 1, the sensor control unit 40 is a unit that controls the light receiving sensor 41 and the light source unit 42, and includes for example, a drive circuit, and the like. The sensor control unit 40 is connected to the print control unit 10 and each electrode lead portion of the spectroscopic unit 411. The sensor control unit 40 outputs the drive control signal to the spectroscopic unit 411, in response to the instruction from the print control unit 10. Thus, a drive voltage based on the drive control signal is applied between the first electrode 4115a and the second electrode 4115b through each electrode lead portion. Then, the electrostatic attractive force acts between the first electrode 4115a and the second electrode 4115b, the gap spacing is adjusted, and the wavelength of the light passing through the spectroscopic unit 411 is determined according to the gap spacing.

Further, the sensor control unit 40 is connected to the light receiving unit 412. The sensor control unit 40 outputs the drive control signal to the light receiving unit 412, in response to the instruction from the print control unit 10. Thus, the electrical signal accumulated in the light receiving unit 412 during the designated measurement time is output to the sensor control unit 40. The sensor control unit 40 outputs the input electrical signal (a value representing the light intensity, and hereinafter simply referred to as “intensity” or “light intensity”), to the print control unit 10.

Further, the sensor control unit 40 is connected to the light source unit 42. The sensor control unit 40 outputs the drive control signal to the light source unit 42, in response to the instruction from the print control unit 10. Thus, during the designated time, it is possible to turn on the light source unit 42.

The print control unit 10 includes, for example, a central processing unit (CPU), a random access memory (RAM) that is used for temporarily storing various types of data, an application specific integrated circuit (ASIC), and the like, and operates according to the control program that is stored in the storage unit 20 so as to integrally control the operation of the printing apparatus 1. The ASIC includes, for example, an interface circuit that controls the CPU, the RAM, the storage unit 20, the print engine unit 30, the sensor control unit 40, the communication unit 50, the operation panel 60, and the like, an image processing circuit that performs various types of image processing, and the like.

The print control unit 10 includes a measurement unit 11, a paper type data generation unit 12, a paper type determination unit 13, an image processing unit 14, and a dry processing unit 15. The measurement unit 11, the paper type data generation unit 12, the paper type determination unit 13, the image processing unit 14, the dry processing unit 15, and other various functions of the print control unit 10 are implemented, for example, by the CPU reading a predetermined control program to the RAM and executing the program. Of course, at least some functions may be implemented by the ASIC and the like.

In addition, the paper type data generation unit 12 corresponds to the generation unit of the invention, and the paper type determination unit 13 corresponds to the determination unit of the invention. Further, at least one of the print control unit 10 and the print engine unit 30 corresponds to the printing unit of the invention.

The print control unit 10 generates print data by performing image processing and the like on, for example, data to be printed on, performs printing on the printing medium by controlling the print engine unit 30 based on the print data, or dries the ink printed on the printing medium by the heater 34.

The measurement unit 11 instructs the sensor control unit 40 to turn on the light source unit 42. Further, the measurement unit 11 operates the carriage 32 so as to cause the print head 33 and the light receiving sensor 41 to reciprocate in the head scanning direction. Further, the measurement unit 11 instructs the sensor control unit 40 to control the light receiving sensor 41 so as to cause light of a plurality of wavelengths to pass through the spectroscopic unit 411 in a plurality of head positions in the head scanning direction, and to output and acquire an electrical signal (value representing a light intensity) of the light of the plurality of wavelengths from the light receiving unit 412.

Further, the measurement unit 11 stores the intensity of the light of the plurality of wavelengths that is output from the light receiving sensor 41 through the sensor control unit 40 in each of the plurality of head positions in the head scanning direction, in the storage unit 20 or the RAM. The intensity of the light of the plurality of wavelengths is referred to as a spectral property (spectrum of light). In addition, when the intensity of the light of the plurality of wavelengths is acquired, the measurement unit 11 or the sensor control unit 40 may perform a gain correction, an interpolation process in the wavelength direction, or the like.

The paper type data generation unit 12 generates paper type data used for determining the paper type of a printing medium, based on the spectral properties in a plurality of head positions in the head scanning direction that are measured by the measurement unit 11, and stores the paper type data in the paper type data storage unit 21. In the present embodiment, the paper type data includes the light reflectance of the paper type in each of a plurality of head positions and a value representing the variation in the reflectance of the paper type in each of the plurality of head positions. The paper type data and the generation of the paper type data will be described later in detail.

In addition, the paper type data corresponds to the property information of the invention. Further, the light intensity, the reflectance, the spectral reflectance, the average spectral reflectance, the covariance, and the covariance matrix, which are described above or will be described later, may be referred to as property information.

The paper type determination unit 13 determines paper type data that is similar to the spectral properties in a plurality of head positions of the printing medium which is measured by the measurement unit 11, among the paper type data pieces stored in the paper type data storage unit 21 (in other words, the paper type which is the type of the printing medium is determined). In addition, the determination of a paper type will be described later in detail. The print control unit 10 acquires the printing parameter corresponding to the paper type that is determined by the paper type determination unit 13 from the printing parameter storage unit 22.

The image processing unit 14 performs an image process on the data to be printed on, based on the printing parameter acquired by the print control unit 10, and generates print data. In addition, the print control unit 10 controls the print engine unit 30 based on the generated print data so as to perform printing on the printing medium.

The dry processing unit 15 controls the heater 34 based on the printing parameter acquired by the print control unit 10 so as to dry the printing medium on which printing is performed.

The storage unit 20 includes, for example, a non-volatile memory such as a mask read only memory (ROM), a flash memory, and a ferroelectric RAM (FERAM). The storage unit 20 stores a control program for controlling the operation of the printing apparatus 1 and various types of data.

The storage unit 20 includes a paper type data storage unit 21 and a printing parameter storage unit 22. The paper type data storage unit 21 stores paper type data for each paper type. The paper type data will be described later in detail. In addition, the paper type data storage unit 21 corresponds to the property information storage unit of the invention.

The printing parameter storage unit 22 stores the printing parameter for each paper type. The printing parameter includes, for example, a parameter regarding at least one of a color conversion process, a halftone process, an ink discharge amount, a paper feeding process, a drying process. The parameter regarding the color conversion process is information indicating, for example, color mapping between different color spaces. The parameter regarding the halftone process is information that defines, for example, a dither mask. The parameter regarding the ink discharge amount is information that defines, for example, a duty cycle of an ink. The parameter regarding the paper feeding process is information indicating, for example, the speed of paper feeding. The parameter regarding the dry processing is information indicating, for example, the temperature, the drying time, and the like of the heater 34.

In addition, although the configuration of the printing apparatus 1 has been described focusing on a main configuration in the description of the properties of the invention, the configuration is not limited to the above description. Further, another configuration of a general printing apparatus is not excluded. Further, the configuration of the printing apparatus 1 has been classified depending on the main processing content in order to facilitate understanding of the configuration of the printing apparatus 1. The invention is not limited depending on the classification manner or name of the components. The configuration of the printing apparatus 1 can be further classified into a number of components, depending on the processing contents. Further, a single component can also be classified to execute more processes. Further, the processes of each component may be implemented by one piece of hardware, or a plurality of pieces of hardware.

Next, the operation example of the printing apparatus 1 will be described.

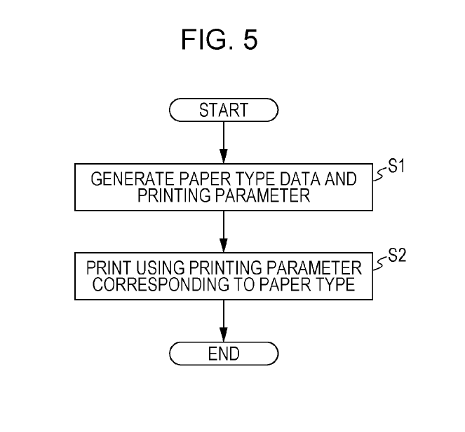

FIG. 5 is a flowchart illustrating a processing outline of the printing apparatus.

As pre-preparation, the printing apparatus 1 generates paper type data and printing parameters regarding the printing mediums of a plurality of paper types used in printing, and stores them in the storage unit 20 (step S1). During actual printing, the printing apparatus 1 determines the paper type of the printing medium to be printed on with reference to the storage unit that stores the paper type data, and acquires the printing parameter corresponding to the determined paper type from the storage unit 20 so as to perform printing on the printing medium (step S2).

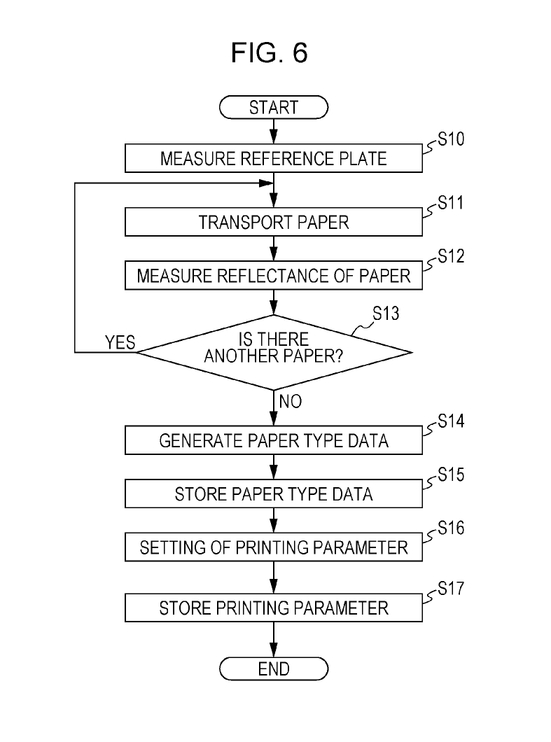

FIG. 6 is a flowchart illustrating an example of a process for generating and storing paper type data. FIG. 6 is a diagram illustrating in detail step S1 in FIG. 5. In addition, a plurality of wavelengths that are measured by the light receiving sensor 41 are determined in advance.

First, the measurement unit 11 measures the reference plate 43 in a state where the printing medium is not being transported (step S10). Specifically, the measurement unit 11 turns on the light source unit 42. Further, the measurement unit 11 operates the carriage 32 to move the light receiving sensor 41 to a predetermined position in the head scanning direction. Further, the measurement unit 11 controls the light receiving sensor 41 so as to cause the light of a plurality of wavelengths that is reflected from the reference plate 43 to pass through the spectroscopic unit 411 in the predetermined position, and output the electrical signal of light of the plurality of wavelengths from the light receiving unit 412. Further, the measurement unit 11 stores the electrical signal of the light of the plurality of wavelengths which is output from the light receiving sensor 41 as light intensities, in the storage unit 20, and the like, in the predetermined position. In addition, after the completion of recording, the measurement unit 11 turns off the light source unit 42, moves the carriage 32 to an initial position, and stops the recording.

Then, the measurement unit 11 transports paper (step S11). Specifically, the measurement unit 11 controls the transport unit 31 so as to start transporting the printing medium that is set in a paper feed tray. In addition, here, the set printing medium is a printing medium for which the paper type data is to be generated, and one or more printing mediums may be set.

Then, the measurement unit 11 measures the reflectance of the paper being transported (step S12). Specifically, the measurement unit 11 starts measurement in a state where the printing medium is passing through the bottom of the print head 33. The measurement unit 11 turns on the light source unit 42. Further, the measurement unit operates the carriage 32 so as to move the light receiving sensor 41 in the head scanning direction. Further, in each of the plurality of head positions in the head scanning direction, the measurement unit 11 controls the light receiving sensor 41 so as to cause light of a plurality of wavelengths to pass through the spectroscopic unit 411, and output an electrical signal of the light of the plurality of wavelengths from the light receiving unit 412. Further, the measurement unit 11 acquires the electrical signal (light intensity) of the light of the plurality of wavelengths that is output from the light receiving sensor 41 in each of the plurality of head positions in the head scanning direction. Further, the measurement unit 11 calculates a value corresponding to the reflectance of light of each wavelength by dividing the acquired light intensity of each wavelength by the light intensity of each wavelength corresponding to the reference plate 43 that is measured in step S10, in each of the plurality of head positions in the head scanning direction, and stores the calculated value in the storage unit 20, and the like. This enables the measurement of the reflectance (also referred to as “spectral reflectance”) of the light of the plurality of wavelengths in the plurality of head positions. In addition, the reflectance may be referred to, to represent the light intensity (relative light intensity with respect to the light intensity of the reference plate).

In step S12, the reflectance in each of a plurality of head positions in the main scanning direction (one line), in one sub-scanning position may be measured, or the reflectance in each of a plurality of head positions for a plurality of lines may be measured. When performing measurement for a plurality of lines, the measurement unit 11 measures the reflectance of light of each wavelength in each head position, for each line. Hereinafter, a description will be made on the assumption of performing measurement for a plurality of lines.

In addition, after completion of the measurement in step S12, the measurement unit 11 turns off the light source unit 42 and stops the measurement by moving the carriage 32 to the initial position. Further, the measurement unit 11 controls the transport unit 31 so as to discharge the measured printing medium to the discharging tray or the like.

Then, the measurement unit 11 determines whether or not there is another paper, in other words, a printing medium for which paper type data is to be generated (step S13). When there is another paper (Y in step S13), the measurement unit 11 performs the process of step S11 again.

When there is not another paper (N in step S13), the paper type data generation unit 12 generates paper type data (step S14). Hereinafter, a detailed description will be made.

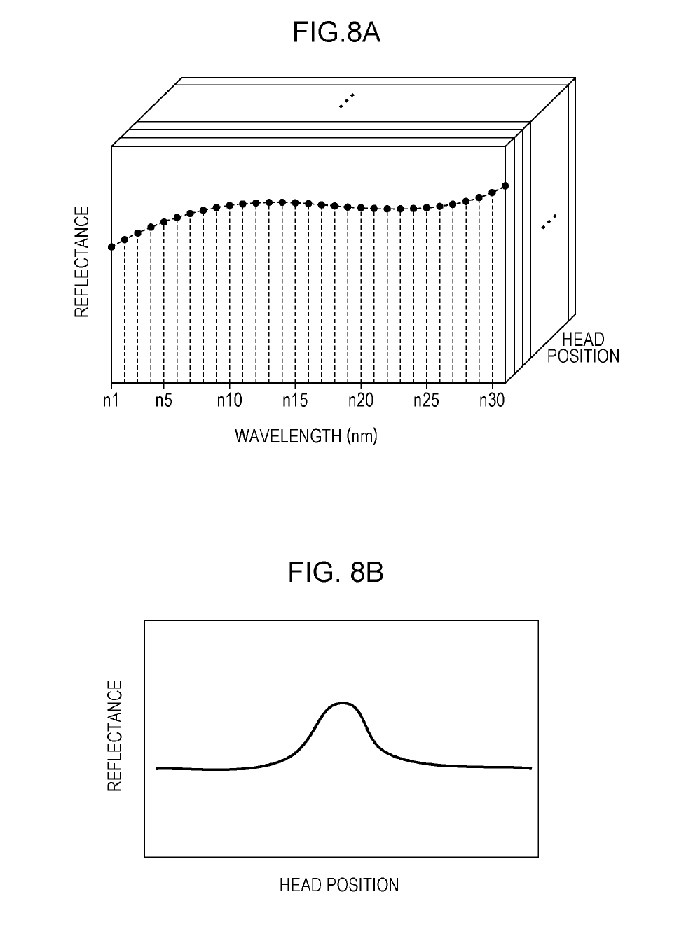

FIGS. 8A and 8B are diagrams illustrating measured spectral reflectance. FIG. 8A illustrates an example of the spectral reflectance of a plurality of head positions in one line for one printing medium. Further, FIG. 8A illustrates the measurement result of the reflectance at each of a plurality of wavelengths, at intervals of a predetermined wavelength width (for example, 10 nm) in a certain wavelength range (for example, 400 nm to 700 nm). In addition, although the reflectance of each of 31 points of wavelengths is measured in FIG. 8A, the number of measurements may be more or less than 31. FIG. 8B illustrates an example of the reflectance over a plurality of head positions, for one wavelength, in the spectral reflectance illustrated in FIG. 8A.

In step S10 to step S13, it is possible to obtain the data as illustrated in FIG. 8A for a plurality of lines, for each printing medium.

The spectral reflectance illustrated in FIGS. 8A and 8B varies depending on the type of printing medium. Accordingly, it is possible to determine the type of printing medium, by measuring the spectral reflectance of the printing medium (before the image is printed) which has been set in the printing apparatus 1. However, there are variations in the measured value of light intensity. Further, even for the same type of printing medium, the variation in the measured value due to a difference in positions to be measured and a difference in production lots is also considered. Thus, even if the values of the spectral reflectance do not completely match, the printing mediums are determined to be the same type. However, if an allowable range is widened, erroneous determination is likely to be performed. Therefore, in the printing apparatus 1 of the present embodiment, the variation in the measured values obtained in different wavelengths (the wavelengths in which head positions are also distinguished) is investigated beforehand, and it is possible to determine the type of printing medium with high accuracy by calculating a kind of statistic amount called a Mahalanobis distance, based on the result. Hereinafter, a description will be made regarding a matrix (covariance matrix) showing the relationship between the measured values between different wavelengths (the wavelengths in which head positions are also distinguished).

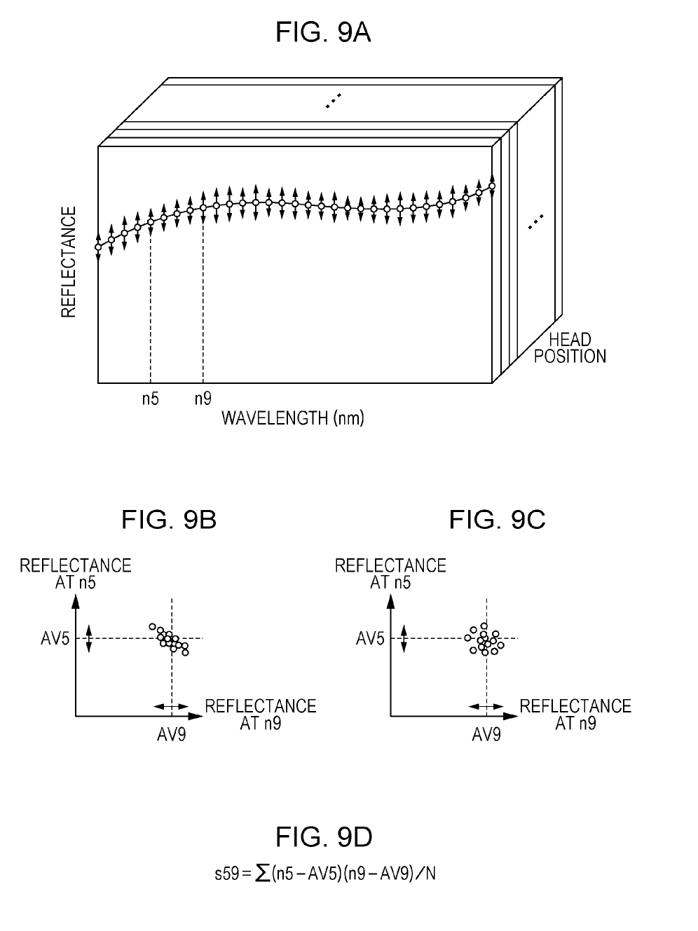

FIGS. 9A to 9D are diagrams describing a method for determining the covariance matrix. FIG. 9A illustrates an example of the spectral reflectance of each of a plurality of head positions in a plurality of lines, for one printing medium. The white circle shown in FIG. 9A represents the average value of the reflectance obtained in each wavelength by the measurement for the plurality of lines. Further, arrows extending in a vertical direction from the white circle represent variations (distribution) of the measured value in the plurality of lines. Here, the average values and the variations illustrated in FIG. 9A are numerical values that are separately calculated for each wavelength, and do not represent a relationship between wavelengths. For example, in a wavelength n5 and a wavelength n9 in a certain head position, it is not considered that both wavelengths do not vary to the same extent. However, if a covariance is obtained, it is possible to know the relationship between respective wavelengths.

For example, FIG. 9B and FIG. 9C illustrate distribution maps representing the relationship between the reflectance in the wavelength n5 and the reflectance in the wavelength n9 which are obtained through every measurement (measurement in a plurality of lines), for the same head position. In FIGS. 9B and 9C, AV5 indicates the average value of the reflectance in the wavelength n5 and AV9 indicates the average value of the reflectance in the wavelength n9. Further, the black arrows indicate the distribution of reflectance at each wavelength. The distribution map in FIG. 9B or FIG. 9C indicates the same variance when viewed in wavelength n5 alone, and indicates the same variance when viewed in wavelength n9 alone. However, as is apparent from the two distribution maps, the relationships between the measured values obtained in the two wavelengths are very different. For example, in the distribution map illustrated in FIG. 9B, when the measured value at the wavelength n5 is greater than the average value AV5, the measured value at the wavelength n9 is likely to be smaller than the average value AV9, and on the contrary, when the measured value at the wavelength n5 is smaller than the average value AV5, the measured value at the wavelength n9 is likely to be greater than the average value AV9. In contrast, in the distribution map illustrated in FIG. 9C, such a tendency is not illustrated at all. The distribution condition in two wavelengths can be expressed using an index called covariance.

FIG. 9D illustrates a calculation equation for determining a covariance s59 between the wavelength n5 and the wavelength n9. n5 and n9 in the equation are the reflectance in the wavelength n5 or the wavelength n9 obtained in every measurement (measurement in a plurality of lines). Further, n in the equation is the number of measurements (number of lines). When the downward-sloping distribution as illustrated in FIG. 9B is obtained, the covariance is a negative value; and in the case of the upward-sloping distribution, the covariance is a positive value. Further, as illustrated in FIG. 9C, as there is no tendency in the distribution, the value of the covariance decreases. Therefore, it is possible to know the distribution condition of the two wavelengths, by obtaining the covariance of the reflectance in the two wavelengths (here, wavelength n5 and wavelength n9). On the contrary, if only the average value and the variance at each wavelength is obtained as illustrated in FIG. 9A, information regarding the distribution condition between the wavelengths illustrated in FIGS. 9B and 9C (in other words, information regarding a relationship of the reflectance of each wavelength) is discarded.

Hitherto, the description has been made regarding the covariance s59 representing the relationship between the reflectance values of the wavelengths, focusing on the wavelength n5 and the wavelength n9, for the same head position. Of course, such a covariance can be considered for the combination of all of the wavelengths. Further, it is possible to consider the combination of all of these wavelengths, by distinguishing the head positions, in other words, by treating the same wavelength at different head positions as different wavelengths.

For example, it is possible to obtain the covariance s1ₚ2ₚ by focusing on the wavelength n1ₚ and the wavelength n2ₚ, and it is possible to obtain the covariance s1ₚ3ₚ by focusing on the wavelength n1ₚ and the wavelength n3ₚ. Here, p represents the head position (range of 1 to P, P is a natural number of 1 or more), and may be a different value in the head position p of each wavelength.

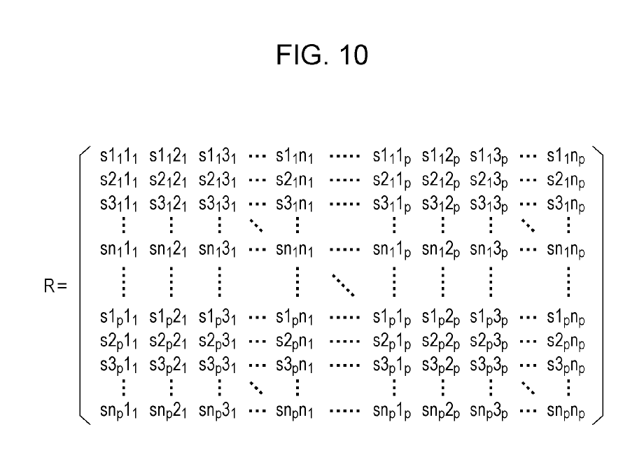

In this manner, a matrix called a “covariance matrix” illustrated in FIG. 10 (a drawing illustrating the covariance matrix) is obtained by expressing the covariance obtained for the combination of all wavelengths in a matrix form. In addition, the values (for example, s1₁1₁, s2₁2₁, and the like) of the diagonal elements in the covariance matrix are dispersed as is apparent from the calculation equation of FIG. 9D. For example, s1₁1₁ represents the variance of the reflectance obtained in the wavelength n1₁, s2₁2₁ represents the variance of the reflectance obtained in the wavelength n2₁. Further, as is apparent from the calculation equation for determining the covariance illustrated in FIG. 9D, a relationship of s1₁2₁=s2₁1₁, s1₁3₁=s3₁1₁ . . . is established. Therefore, the covariance matrix always becomes a symmetric matrix.

Returning back to the description of FIG. 6, in step S14, the paper type data generation unit 12 generates paper type data for each measured printing medium. In other words, the paper type data generation unit 12 obtains the average value of the reflectance obtained for each wavelength in each head position in the measurement of every line (also hereinafter, referred to as “average spectral reflectance”) and the covariance matrix, for each printing medium as described above, and the obtained average value and covariance matrix are generated as the paper type data. Then, the paper type data generation unit 12 stores the paper type data of each printing medium generated in step S14, in the paper type data storage unit 21 (step S15).

Then, the paper type data generation unit 12 receives the setting of the printing parameter (step S16). Specifically, the paper type data generation unit 12 receives the setting of the printing parameter for each printing medium through a terminal such as a PC or the operation panel 60 which is capable of transmitting through the communication unit 50, from the user. At this time, the paper type data generation unit 12 may output and display the paper type data of each printing medium that is stored in step S15, to and on the terminal or the operation panel 60. The details of the printing parameter are as described above.

Then, the paper type data generation unit 12 stores the printing parameter of each printing medium that is set in step S16, in the printing parameter storage unit 22 (step S17), and ends the process of the flowchart illustrated in FIG. 6.

In this manner, since the paper type data and the printing parameter of each printing medium are generated and stored, it is possible to determine the paper type with high accuracy and perform appropriate printing according to the determined paper type in the printing process to be described below.

In addition, in the present embodiment, the printing apparatus 1 performs the generation of paper type data and the setting of a printing parameter, but for example, the printing apparatus 1 may download a set of the paper type data and the printing parameter, from a predetermined server on a network by the communication unit (for example, a printing apparatus manufacturer's or a paper manufacturer's site), and store the set in the storage unit 20. Further, for example, the printing apparatus 1 may upload the set of the paper type data and the printing parameter that is stored in the storage unit 20 through the process in FIG. 6, to a predetermined server (for example, a printing apparatus manufacturer's or a paper manufacturer's site) on a network through the communication unit 50, and another user may use the set.

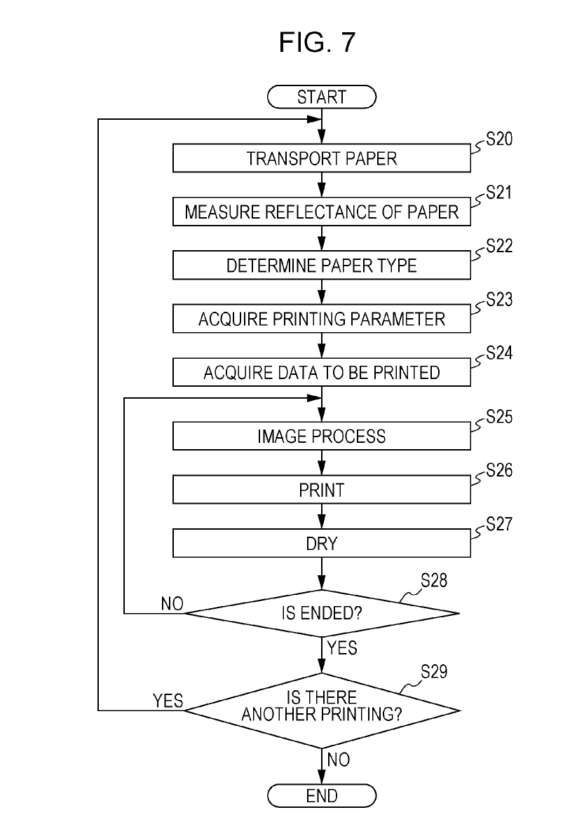

FIG. 7 is a flowchart illustrating an example of the printing process. FIG. 7 is a diagram illustrating step S2 in FIG. 5 in detail.

First, the measurement unit 11 transports paper (step S20). Specifically, the measurement unit 11 controls the transport unit 31 so as to start transporting the printing medium that is set in a paper feed tray. In addition, here, the set printing medium is a printing medium that is used for actual printing.

Then, the measurement unit 11 measures the reflectance of the paper being transported (step S21). Specifically, the measurement unit 11 starts measurement in a state where the printing medium is passing through the bottom of the print head 33. The measurement unit 11 turns on the light source unit 42. Further, the measurement unit operates the carriage 32 so as to move the light receiving sensor 41 in the head scanning direction. Further, in each of the plurality of head positions in the head scanning direction, the measurement unit 11 controls the light receiving sensor 41 so as to cause light of a plurality of wavelengths to pass through the spectroscopic unit 411, and output the electrical signal of the light beam of the plurality of wavelengths from the light receiving unit 412. Further, the measurement unit 11 acquires the electrical signal (light intensity) of the light of the plurality of wavelengths that is output from the light receiving sensor 41, in each of the plurality of head positions in the head scanning direction. Further, the measurement unit 11 calculates a value corresponding to the reflectance of light of each wavelength by dividing the acquired light intensity of each wavelength by the light intensity of each wavelength of the reference plate 43 that is stored in the storage unit 20 and the like, in each of the plurality of head positions in the head scanning direction, and stores the calculated value in the storage unit 20, and the like. In this manner, it is possible to measure the reflectance of light of each wavelength (spectral reflectance) in the plurality of head positions.

In step S21, the reflectance at the plurality of head positions is measured for one line. Of course, the reflectance at the plurality of head positions may be measured for a plurality of lines.

Then, the paper type determination unit 13 determines the paper type of the printing medium, based on the spectral reflectance measured in step S21 and the paper type data stored in the paper type data storage unit 21 (step S22). Hereinafter, a detailed description will be made.

The paper type determination unit 13 calculates a Mahalanobis distance between the spectral reflectance measured in step S21 and each sample (each paper type). In the present embodiment, since the paper type data (average spectral reflectance and covariance matrix) of each sample is stored in the paper type data storage unit 21, the Mahalanobis distances of the number of the paper type data pieces is calculated.

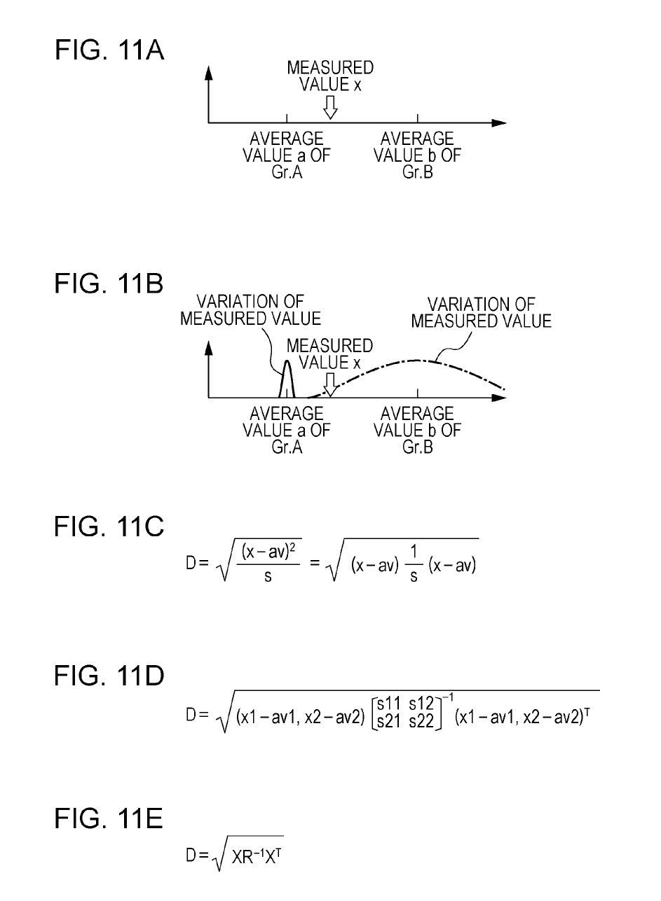

FIGS. 11A to 11E are diagrams illustrating a Mahalanobis distance. In situations where the average value a of a group (here, referred to as Gr.A) and the average value b of another group (here, referred to as Gr.B) are divided, it is assumed that the measured value x for a new sample is obtained. As illustrate in FIG. 11A, if the measured value x is closer to the average value a than the average value b (deviation is small), the sample is usually considered to belong to Gr.A. However, this is established on the assumption that the variation in the measured value is equal in the Gr.A and Gr.B. Therefore, considering the variation in the measured value of Gr.A and Gr.B, the reversed conclusion may also be obtained.

For example, in the case illustrated in FIG. 11B, for example, even if the measured value x of the sample is closer to the average value a than the average value b, it is considered that the sample belongs to Gr.B. In other words, although the deviation between the measured value x and the average value a is definitely smaller than the deviation between the measured value x and the average value b, if the sample is considered to belong to Gr.A, the deviation between the measured value x and the average value a can be too large compared to the variation of the measured value of Gr.A. In contrast, since the deviation between the measured value x and the average value b is smaller as compared to the variation of the measured value of Gr.B, the sample is naturally considered to belong to Gr.B. In this manner, it is possible to perform more accurate determination by considering not only the deviation between the measured value and the average value, but also the ratio of the deviation to the variation (variance) of the measured value. The Mahalanobis distance is an indicator that indicates a group to which the sample belongs, in consideration of the variation of the measured value. The higher the possibility of the sample belonging to a certain group is, the smaller the Mahalanobis distance for the group is.

As illustrated in FIG. 11B, if the measured value x is one-dimensional, it is possible to calculated the Mahalanobis distance (accurately, the squared value of the Mahalanobis distance) by squaring the deviation between the measured value and the average value and dividing the obtained value by the variance. FIG. 11C illustrates a calculation equation for obtaining the Mahalanobis distance. In the equation, x indicates a measured value, av indicates an average value, and s indicates variance.

Further, the Mahalanobis distance can be extended to multi-dimension. A two-dimensional Mahalanobis distance will be described as the simplest case. In the two-dimensional case, two measured values of x1 and x2 are obtained every time of measurement. With respect to the variance, it is possible to consider not only the variance for x1 and the variance for x2, but also the covariance between x1 and x2. Therefore, it is possible to obtain a calculation equation for obtaining a two-dimensional Mahalanobis distance illustrated in FIG. 11D, by replacing the measured value x in the calculation equation illustrated in FIG. 11C with a vector (x1, x2), and the variance s with the covariance matrix. In addition, in the equation, av1 and av2 respectively represent average values of x1, x2. Further, “−1” attached to the upper light part of the covariance matrix represents an inverse matrix. In addition, “−1” attached to the vector (x1, x2) represents the transposed vector.

In the calculation equation illustrated in FIG. 11D, if (x1−av1.x2−av2) is represented by an upper-case letter “X”, and the covariance matrix is represented by an upper-case letter “R”, the calculation equation of the two-dimensional Mahalanobis distance can be represented by FIG. 11E. The calculation equation in FIG. 11E can be used as the calculation equation of the multidimensional Mahalanobis distance of three-dimensional or more, as it is. In other words, when the n-dimensional Mahalanobis distance is calculated, “X” is a vector with n components, and “R” is the covariance matrix of n rows and n columns.

Since the spectral reflectance obtained in step S21 in FIG. 7 is the reflectance of each of n×P wavelengths, in which n wavelengths are obtained in each head position p (a range of 1 to P, P is a natural number of 1 or greater), n×P dimensional measured value (see FIGS. 8A and 8B). Further, the covariance matrix which is obtained from the spectral reflectance is a matrix of n×P rows and n×P columns (see FIG. 10). Then, the average spectral reflectance and the covariance matrix for a plurality of samples are stored in the paper type data storage unit 21. Thus, in step S22, the Mahalanobis distance from the spectral reflectance to each sample that is measured in step S21 is calculated by using the calculation equation of FIG. 11E. Then, a sample (paper type) having the smallest value of the Mahalanobis distance is selected, and the paper type is determined to be the paper type of the printing medium on which printing is performed.

In addition, although the paper type having the smallest value of the Mahalanobis distance is selected in step S22, for example, the paper type determination unit 13 determines whether or not the smallest Mahalanobis distance is more than a predetermined threshold, and when the distance is more than the predetermined threshold, a message in which an appropriate paper type is not registered or a message prompting the registration of the paper type data and the printing parameter may be output on and displayed to a terminal such as a PC which is capable of transmitting through the communication unit 50 or the operation panel 60.

Then, the print control unit 10 acquires the printing parameter corresponding to the paper type that is determined in step S22, from the printing parameter storage unit 22 (step S23). Further, the print control unit 10 acquires data to be printed that is stored in the storage unit 20, and the like (step S24). The data to be printed is, for example, image data having data of each color of R (red), G (green), and B (blue).

Then, the print control unit 10 executes various image processes on the data to be printed acquired in step S24, based on the printing parameter acquired in step S23 (step S25). Specifically, the image processing unit 14 applies the image processes on the data to be printed, based on the printing parameter (for example, parameters regarding a color conversion process, a halftone process, an ink discharge amount, a paper feed process, and the like) acquired in step S23, and generates print data. The print data is, for example, dot data indicating on and off of the discharge of ink.

Further, the print control unit 10 controls the print engine unit 30, based on the print data generated in step s25 so as to perform printing on the printing medium (step S26). In addition, the process in step S6 may be performed based on the printing parameter (for example, a parameter regarding a paper feed process, and the like). Further, the print control unit 10 performs the dry processing (step S27). Specifically, the dry processing unit 15 controls the heater 34, based on the printing parameter (a parameter regarding the dry process) acquired in step S23 so as to dry the position where printing has been completed in step S26.

Then, the print control unit 10 determines whether or not the printing of a predetermined range (for example, one page) has been completed (step S28). When the printing has not been completed (N in step S28), the print control unit 10 performs the process of step S25 again.

In addition, in the present embodiment, the print control unit 10 controls the transport unit 31 so as to transport the printing medium and perform the processes of step S25 to step S28.

When the printing has been completed (Y in step S28), the print control unit 10 determines whether or not there is another printing (for example, next page) (step S29). When there is another printing (Y in step S29), the print control unit 10 returns the process to step S20. When there is no another printing (N in step S29), the print control unit 10 ends the process of the flowchart illustrated in FIG. 7.

In addition, in order to facilitate understanding of the process of the printing apparatus 1, respective processing units in the flowchart illustrated in FIG. 6 and FIG. 7 are obtained by dividing the process depending on the main processing contents. The invention is not limited by the method and the name of the division of the processing unit. The process of the printing apparatus 1 can also be further divided into a number of processing units, depending on the processing contents. Further, one processing unit may be divided to include further more processes.

Hitherto, an embodiment of the invention has been described. In the present embodiment, the type of the printing medium is determined prior to the printing of the image, and the image is printed according to the determination result. For this reason, even if the user of the printing apparatus do not set the type of printing medium, it is possible to determine the type of the printing medium automatically and print an appropriate image. Furthermore, it is also possible to automatically perform the printing parameter setting and the like of the printing medium.

Further, when determining the type of printing medium, the average spectral reflectance and the covariance matrix for a plurality of samples are stored in advance, and the type of printing medium is determined by calculating the Mahalanobis distance for each sample. It is possible to consider not only variation (variance) of the measured value in each wavelength, but also a relationship (such as distribution condition) between a plurality of wavelengths by using the covariance. Therefore, if the type of the printing medium is determined based on the Mahalanobis distance that is calculated by using the average spectral reflectance and the covariance matrix, it is possible to select the sample which is closest to the measured spectral reflectance in consideration of not only the reflectance in each wavelength but also the relationship of the reflectance values between the respective wavelengths. Therefore, it is possible to correctly determine the type of the printing medium with a very high probability. As a result, it is possible to appropriately print an image, without printing the image while the type of the printing medium has been incorrectly set by the user of the printing apparatus, or the previous setting remains because the user has forgot the setting.

Of course, a case can also occur where the printing medium for which the spectral reflectance is measured is the printing medium of a type of which data as a sample is not stored (unknown printing medium). In such a case, the printing medium may be determined to be a printing medium of a type different from the actual one. However, determining the same type as that of the sample having the smallest Mahalanobis distance is determining the sample which is most similar to the printing medium. Therefore, even if there is a unknown printing medium, in an available range of the printing apparatus, the image process which is considered to be the most appropriate is performed, and thus it is possible to print an appropriate image.

Further, in the present embodiment, the reflectance of each wavelength is measured for a plurality of head positions, and the average reflectance and the covariance matrix are calculated based on the measurement result, and are stored as the paper type data. Then, in actual printing, the paper type is determined by using the reflectance of each wavelength that is measured for the plurality of head positions and the average reflectance and the covariance matrix of each sample that are stored. In this manner, since the Mahalanobis distance in view of the reflected light (specular reflected light and diffuse reflected light) at the plurality of different head positions is obtained by using the measurement result in the plurality of head positions, it is possible to more accurately determine the paper type. In other words, since the determination accuracy of not only the color of the printing medium but also the properties such as the thickness, the material, and the gloss (surface condition) is increased, it is possible to more accurately determine the type of medium even when the properties are slightly different, and select the printing parameter suitable for the paper type.

Further, in the present embodiment, since the light receiving sensor is provided in the print head which is a moving unit and the light source is provided in the non-moving unit of the printing apparatus, it is possible to easily measure the light intensity at the plurality of head positions by using scanning of the print head. Further, since it is sufficient to add the light receiving sensor and the light source in the printing apparatus, it is possible to reduce the manufacturing cost of hardware. Further, since a Fabry-Perot spectrometer is used, it is possible to make the light receiving sensor more compact.

Further, in the present embodiment, various parameters regarding a color conversion process, a halftone process, an ink discharge amount, a paper feeding process, a drying process, and the like are prepared as the printing parameters, and printing is performed based on the parameters. Therefore, it is possible to reduce the burden on the user who sets a number of printing parameters, depending on the type of printing medium.

### Modification

In the above embodiment, the Mahalanobis distance is calculated by using the measured spectral reflectance as it is. Since the measured spectral reflectance is the reflectance of each of the plurality of wavelengths, the Mahalanobis distance is calculated in multiple dimensions. If the number of measured wavelengths is reduced, the measurement becomes faster and the calculation of the Mahalanobis distance becomes faster, but if the number of measured wavelengths is reduced, the deterioration in recognition accuracy of the printing medium is a concern. Therefore, the Mahalanobis distance is not calculated by using the measured spectral reflectance as it is, the number of dimensions of the spectral reflectance is reduced by using the principal component analysis, and the type of printing mediums may be determined by calculating the Mahalanobis distance in a small number of dimensions.

In the above embodiment, the description has been made assuming that the number of wavelengths is n×P, but in the following description, a description will be made assuming n=n×P. In other words, the measured value is n dimensional and the covariance matrix is n rows and n columns.

First, a method of reducing the number of dimensions by using the principal component analysis will be described. In addition, since the principal component analysis itself is a well-known method, an outline will be described later. In order to reduce the number of dimensions by using the principal component analysis, it is necessary to obtain the principal component vector. Although the principal component vector can be obtained in various methods, here, a method using the covariance matrix will be described. Since the covariance matrix is a symmetric matrix, a plurality of eigenvectors are orthogonal, or the eigenvalue corresponding to each eigenvector is a real number. Then, the covariance matrix can be developed using the plurality of eigenvectors and the eigenvalue corresponding to each eigenvector.

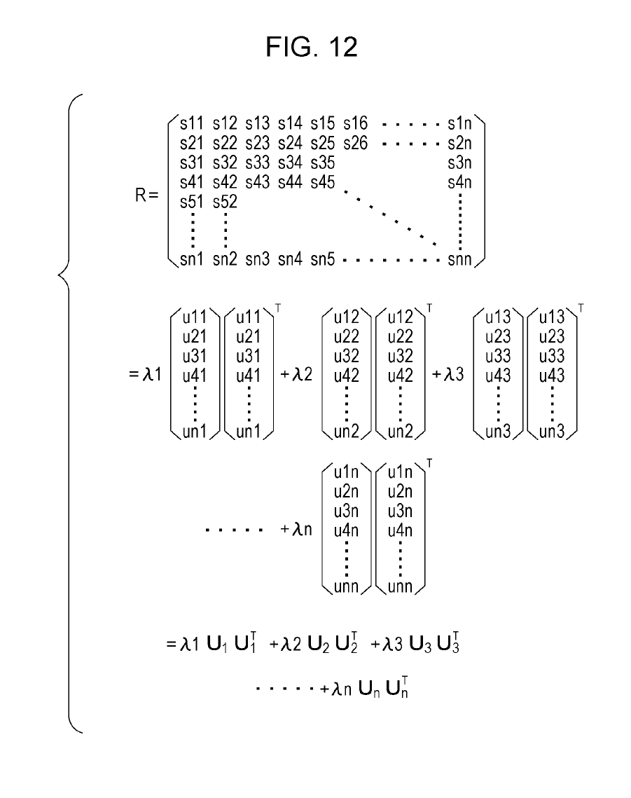

FIG. 12 (a diagram illustrating a state in which the covariance matrix is developed) illustrates a state in which the covariance matrix R is developed by using a plurality of eigenvalues λ and a column vector for each eigenvalue λ. In addition, U₁ in the equation represents a first eigenvector, and λ1 represents an eigenvector for U₁. Further, U₂ in the equation represents a second eigenvector, and λ2 represents an eigenvector for U₂. Hereinafter, similarly, Uₙ in the equation represents a n-th eigenvector, and λn represents an eigenvector for Uₙ. Further, the eigenvalues and the eigenvectors of the number corresponding to the number of dimensions of the covariance matrices R. Among eigenvectors obtained in this manner, upper eigenvectors are used as the principal component vector, and thus it is possible to reduce only the number of dimensions, while hardly impairing information about the measured spectral reflectance.

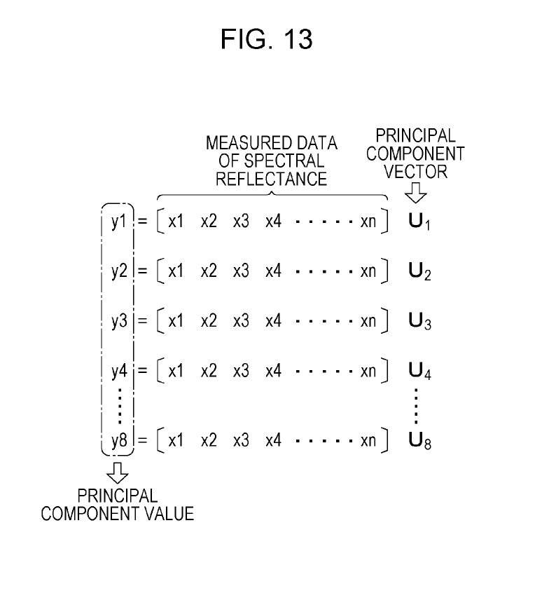

FIG. 13 (a diagram illustrating a state in which a principal component value is extracted) illustrates a state in which the number of dimensions of the measured spectral reflectance by using the upper eigenvectors as the principal component vectors. In the illustrated example, the eight upper eigenvectors are used as the principal component vector. Further, the principal component vector is a column vector having the same dimension as the number of dimensions of the spectral reflectance. Here, it is assumed that data of n dimensional spectral reflectance (x1, x2, . . . , xn) are obtained. The inner product of the data of the spectral reflectance and the first principal component vector U₁ is obtained, the obtained principal component value is set to y1. Further, the inner product of the data of the spectral reflectance and the second principal component vector U₂ is obtained, the obtained principal component value is set to y2. If the inner product for each principal component vector is obtained in this manner, it is possible to obtain the principal component value y of the number corresponding to the number of principal component vectors (eight in the example illustrated in FIG. 13). In other words, the number of dimensions of the obtained spectral reflectance is reduced to the number of dimensions corresponding to the number of the principal component vectors.

Further, the case of reducing the number of dimensions by using the principal component vector in this manner is different from the case of reducing the number of dimensions simply by thinning the wavelength for measuring the reflectance, and it has originally been known that there is little loss of information. Further, although the lower eigenvectors are not used as the principal component vector, the principal component value for such lower principal component vector is considered as a noise component. Accordingly, it is possible to remove noise components by reducing the number of dimensions.

In the modification, since the Mahalanobis distance is calculated by using the principal component value y instead of the spectral reflectance, it is possible to more stably determine the type of the printing medium without being affected by the noise components.

The operation of the printing apparatus 1 according to the modification is basically the same as in FIG. 6. However, the processes in step S14 and step S15 are different from the embodiment. In other words, in step S14 and step S15, the paper type data generation unit 12 generates the average value and the covariance matrix for each principal component value as the paper type data by using a plurality of principal component values instead of the reflectance at each measured wavelength (distinguishing the head position) for each measured printing medium, and stores the generated average value and covariance matrix in the paper type data storage unit 21.

Further, the operation of the printing apparatus 1 according to the modification is basically the same as in FIG. 7. However, the process in step S22 is different from the embodiment. In other words, in step S22, the paper type determination unit 13 extracts a plurality of principal component values from the spectral reflectance measured in step S21 by obtaining an inner product for a plurality of principal component vectors that are obtained in advance. Further, the paper type determination unit 13 calculates the Mahalanobis distance between the principal component value extracted in step S21 and the paper type data of each sample (the average value and the covariance matrix for each principal component value). The paper type determination unit 13 selects the sample (paper type) having the minimum Mahalanobis distance, and determines the paper type as the paper type of a printing medium for printing.

Hitherto, the modification of the embodiment has been described. In the modification, since the number of dimensions can be reduced at the time of calculating the Mahalanobis distance, the type of the printing medium can be quickly determined by quickly calculating the Mahalanobis distance. Further, since the principal component vector, the average value of the principal component value, and the covariance matrix for the principal component value can be obtained in advance, actual calculation is not complicated. Of course, a process of calculating the principal component value for each principal component vector from the measured spectral reflectance is newly required, but the process is ended in a very short time because this process simply obtains the inner product between vectors. Accordingly, it is possible to significantly reduce the time required to determine the type of the printing medium.

Further, when the measured spectral reflectance is converted into a less dimensional principal component value, the noise component is removed, and the properties for each type of the printing medium is clearer. As a result, it is possible to more stably determine the type of the printing medium.

Hitherto, the invention has been described using the embodiment and the modification, but the invention is not limited to the above embodiment and modification, and can be realized in various forms without departing from the scope.

For example, in the above embodiment and the modification, the light receiving sensor 41 is provided in the print head 33 which is a moving unit, and the light source unit 42 is provided in the inner wall of the housing of the printing apparatus 1 which is the non-moving unit, but the installation position may be reversed.

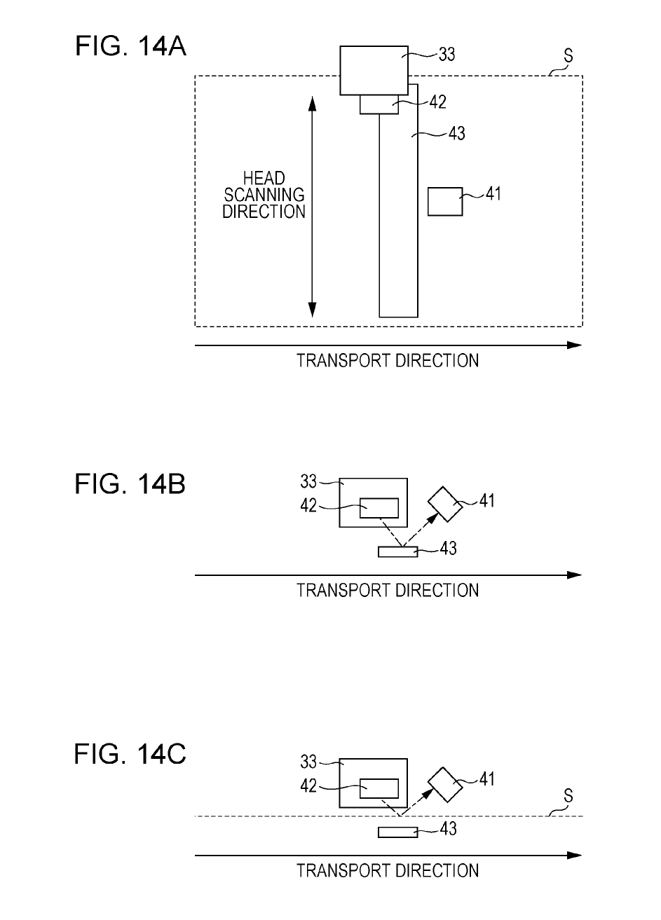

FIGS. 14A to 14C are diagrams illustrating another example of the arrangement of the light receiving sensor and the light source unit. In FIGS. 14A to 14C, the illustration is focused on the arrangement of the light receiving sensor 41 and the light source unit 42, and the other configuration components such as the carriage 32 are appropriately omitted. FIG. 14A is a diagram when the printing apparatus 1 is viewed in a vertical direction relative to the transport direction and the head scanning direction, FIG. 14B is a diagram when the printing apparatus 1 is viewed in the head scanning direction (in a state where the printing medium S is not being transported), and FIG. 14C is a diagram when the printing apparatus 1 is viewed in the head scanning direction (in a state where the printing medium S is being transported).

The light source unit 42 is provided in the print head 33, and emits light in the direction of at least the printing medium S and the reference plate 43. The light source unit 42 is integrated with the print head 33 by the operation of the carriage 32, and reciprocates in the head scanning direction.

The light receiving sensor 41 is attached to, for example, an inner wall of a housing of the printing apparatus 1. Further, the light receiving sensor 41 faces the direction of the printing medium S and the reference plate 43 so as to detect the light reflected from the printing medium S and the reference plate 43.

A transport path through which the printing medium S passes in the transport direction is present below the print head 33, the light receiving sensor 41, and the light source unit 42. The reference plate 43 is disposed below the printing medium S, and extends in the head scanning direction. In a state where the printing medium S is not being transported, the reference plate 43 reflects the light emitted from the light source unit 42 to at least the light receiving sensor 41. The printing medium S also reflects the light emitted from the light source unit 42 to at least the light receiving sensor 41.

In this manner, in the present variation, with a simple configuration in which the light receiving sensor 41 is fixed to a static position such as the inner wall of the housing of the printing apparatus 1 and the light source unit 42 is fixed to the print head 33, it is possible to receive the light (specular reflected light and diffuse reflected light) reflected from the printing medium S and the reference plate 43, in each head position in the head scanning direction of the print head 33, by the light receiving sensor 41. In other words, it is possible to receive the reflected light at each position by the light receiving sensor 41, while changing the relative position of the light receiving sensor 41 and the light source unit 42.

Further, for example, although the light receiving sensor 41 is provided in the print head 33 in the above embodiment, the light receiving sensor 41 may be provided in another moving unit such as the carriage 32. Similarly, although the light source unit 42 is provided in the print head 33 in the modification, the light source unit 42 may be provided in another moving unit such as the carriage 32.

Further, for example, although a Fabry-Perot spectrometer is used for the light receiving sensor 41 and a light source such as an LED is used for the light source unit 42 in the above embodiment and modification, as long as the light intensities of a plurality of wavelengths can be measured, there is no limit to such a configuration.

Specifically, the light source unit 42 includes, for example, a Fabry-Perot spectrometer, a light source such as an LED that emits light of a plurality of wavelengths, an optical member such as an optical fiber and a lens that guides the light from the light source to the spectroscope, and an optical member such as a lens and an optical fiber that guides the light passing through the spectroscope and emits the light to the outside. Since the wavelength of the light passing through the spectroscope is selected in response to the drive control signal from the sensor control unit 40, the wavelength of the light that is emitted by the light source unit 42 is determined. Meanwhile, the light receiving sensor 41 includes, for example, a light receiving unit such as a photodiode, and an optical member such as an optical fiber and a lens that guides the light from the outside to the light receiving unit. The light receiving sensor 41 outputs the accumulated electrical signal in response to the drive control signal from the sensor control unit 40. Even in this way, the measurement unit 11 can measure the light intensities of a plurality of wavelengths at a plurality of head positions. Further, since the Fabry-Perot spectrometer is used, the light source capable of switching the wavelength of the light to be emitted can be made compact.

Further, for example, in the above embodiment and the modification, the description has been made assuming that the printing apparatus 1 is a so-called ink jet printer. However, the invention can be suitably applied to a printing apparatus of a different scheme, as long as it can print an image by adhering color material on the printing medium by the print head.

The entire disclosure of Japanese Patent Application No. 2014-106219 filed on May 22, 2014 is expressly incorporated by reference herein.

What is claimed is:

1. A printing apparatus comprising:
a light receiving sensor provided in one of a moving unit and a non-moving unit;
a light source provided in the other of the moving unit and the non-moving unit;
a measurement unit that measures an intensity of light that is emitted from the light source and reflected on a printing medium to be printed on, a plurality of times, while the moving unit moves; and
a determination unit that determines a type of the printing medium to be printed on, based on an intensity of the light that is measured the plurality of times by the measurement unit.

2. The printing apparatus according to claim 1,
wherein the moving unit is a print head, and
wherein the measurement unit measures an intensity of light that is reflected on the printing medium to be printed on, while the print head moves.

3. The printing apparatus according to claim 1, further comprising:
a property information storage unit that stores a first type of property information that is generated based on an intensity of light that is measured in advance, for each type of the printing medium,
wherein the determination unit determines the type of the printing medium to be printed on, based on a second type of property information of the printing medium to be printed on that is generated based on an intensity of light that is measured the plurality of times and the first type of property information that is stored in the property information storage unit.

4. The printing apparatus according to claim 3, further comprising:
a printing parameter storage unit that stores a printing parameter used in a printing process, for each printing medium; and
a printing unit that performs a printing process on the printing medium to be printed on, according to the printing parameter corresponding to the type of the printing medium that is determined by the determination unit.

5. The printing apparatus according to claim 4,
wherein the printing parameter includes a parameter regarding at least one of a color conversion process, a halftone process, an ink discharge amount, a paper feeding process, and a drying process.

6. The printing apparatus according to claim 1,
wherein one of the light receiving sensor and the light source includes a Fabry-Perot spectrometer.

7. The printing apparatus according to claim 1,
wherein the light source emits light of at least two or more wavelengths,
wherein the light receiving sensor receives the light of at least two or more wavelengths,
wherein the measurement unit measures an intensity of the light of at least two or more wavelengths that is emitted from the light source and reflected on the printing medium to be printed on, for each of a plurality of times of measurements, and
wherein the determination unit determines the type of the printing medium to be printed on, based on an intensity of the light of at least two or more wavelengths that is measured for each of the plurality of times of measurements.

8. A printing method of a printing apparatus comprising:
measuring an intensity of light that is emitted from a light source and reflected on a printing medium to be printed on, a plurality times, while the moving unit moves; and
determining a type of the printing medium to be printed on, based on an intensity of the light that is measured a plurality of times by the measurement unit.
